(19) United States
(12) Patent Application Publication
(10) Pub. No.: US 2025/0236745 A1
(43) Pub. Date: Jul. 24, 2025

(54) MAGNET WITH BOND COATING, MAGNETIC ASSEMBLY, AND ELECTRICAL DEVICE

(71) Applicants: BEIJING ZHONG KE SAN HUAN HI-TECH CO., LTD., Beijing (CN); TIANJIN SANHUAN LUCKY NEW MATERIAL CO.,LTD., Tianjin (CN)

(72) Inventors: Xiaogang BAI, Beijing (CN); Haihua YU, Beijing (CN); Xue HAN, Beijing (CN); Yangzi FU, Beijing (CN)

(21) Appl. No.: 19/173,443

(22) Filed: Apr. 8, 2025

Related U.S. Application Data
(63) Continuation of application No. PCT/CN2023/072996, filed on Jan. 18, 2023.

(30) Foreign Application Priority Data
Dec. 19, 2022 (CN) 202211635264.5

(51) Int. Cl. C09D 7/40; C09D 7/62; C09D 133/08; C09D 151/08; H02K 1/27

(52) U.S. Cl. CPC C09D 7/70; C09D 7/62; C09D 133/08; C09D 151/08; H02K 1/27

(57) ABSTRACT

A magnet includes a magnet matrix and a bond coating. The bond-coating is attached to at least part of an outer surface of the magnet matrix. The bond-coating includes an adhesive composition, which includes a base resin and a foaming agent. The foaming agent in the bond-coating is close to the magnet matrix, and a distribution height of the foaming agent is less 50% of a thickness of the bond-coating in a cross-section.

### CROSS-REFERENCE TO RELATED APPLICATIONS

This application is a continuation of International Application No. PCT/CN2023/072996, filed on Jan. 18, 2023, which claims priority to Chinese Application No. 202211635264.5, filed on Dec. 19, 2022, the entire contents of both of which are incorporated herein by reference.

### TECHNICAL FIELD

The present disclosure relates to the field of polymer materials and, in particular, to a magnet with bond-coating, magnetic assembly and electrical device.

### BACKGROUND

Permanent magnet motors are widely used in new energy vehicles, making the assembly of motor magnets one of the critical processes in the production of new energy vehicles. How to achieve a higher bonding strength between the magnet and the magnetic conductor in the motor is an urgent technical problem to be solved

Currently, adhesives are typically applied to the magnets and/or the magnetic conductors, and then the magnets are bonded to the magnetic conductors and cured, thereby forming a cured bond-coating between the magnet and the magnetic conductor. The bond strength between the bonding layer and the magnet, the bond strength between the adhesive and the magnetic conductor, and the strength of the adhesive itself are all important factors that affect the bond strength between the magnet and the magnetic conductor.

Chinese patent publication CN102934329A discloses a rotor for an electric motor, comprising: a rotor core, a permanent magnet, and a rotor shaft, wherein the permanent magnet is fixed by a resin material, and the resin material is filled between the inner wall of the permanent magnet insertion hole in the rotor core and the side surface of the permanent magnet, to complete the bonding effect between the magnet and the rotor core.

Chinese patent publication CN106824730A discloses a powder coating prepared from thermosetting bisphenol A epoxy polyester resin powder, p-toluenesulfonyl hydrazide expanding agent, and dimethyl imidazole curing agent, which is applied to the surface of the magnet and subjected to intermediate curing at 70-120° C. After inserting into the motor's slot, it undergoes final curing at 120-200° C. to complete the bonding between the magnet and the slot.

In Japanese patent publication JP2007174872A, a method is disclosed that uses a room-temperature solid resin. To improve the impact resistance of the bonding sheet, a foaming agent is added to the resin to prepare a resin foam sheet, thereby obtaining a cured material containing bubbles in its interior. Using the resin foam sheet to replace solvent-based adhesives can overcome problems such as adhesive overflow, uneven application, and deformation or peeling of the adhesive, thereby improving assembly efficiency and machining precision.

However, the bond strength between the magnet and the magnetic conductor in existing motors still needs to be further improved.

### SUMMARY

The disclosure content is provided to briefly introduce the concepts that will be detailed in the specific implementation section later. The content is not intended to identify the key features or essential features of the technical solution to be protected, nor is it intended to limit the scope of the technical solution to be protected.

A first aspect of the disclosure provides a magnet with bond-coating. The magnet comprises a magnet matrix and a bond coating, The bond-coating is attached to at least part of the outer surface of the magnet matrix. The bond-coating is obtained after the attachment of an adhesive composition, which includes a base resin and a foaming agent. The foaming agent in the bond-coating is close to the magnet matrix, and the distribution height of the foaming agent is less 50% of the cross-sectional thickness of the bond-coating.

A second aspect of the disclosure provides a magnetic assembly. The magnetic assembly comprises a magnet and a magnetic conductor. There is an adhesive bonding layer obtained after the bond-coating between the magnet and the magnetic conductor is thermally cured at a temperature ranging from 150° C. to 200° C. The adhesive bonding layer obtained after thermal curing contains expansion bubbles. These expansion bubbles are adjacent to the magnet matrix, and the distribution height of the expansion bubbles is less than 80% of the thickness of the cross-section of the adhesive bonding layer obtained after thermal curing.

A third aspect of the disclosure provides an electrical device, the electrical device comprising the magnetic assembly as described above.

Through the above technical solution, the present disclosure improves the bonding performance between the expanded adhesive bonding layer and the magnetic conductor by using a magnet with bond-coating.

The other features and advantages will be detailed in the subsequent specific implementation section.

### BRIEF DESCRIPTION OF THE DRAWING

Combining the accompanying drawings and referring to the specific implementations below, the above and other features, advantages, and aspects of each of the embodiments will become more apparent. It should be understood that the drawings are illustrative and the components and elements are not necessarily drawn to scale. In the drawings:

FIG. 1 is a schematic diagram of the magnet with bond-coating before and after expansion;

FIG. 2 is an electron microscopic observation photograph of the cross-sectional structure of the bond-coating in the magnet of Example 1 before expansion.

FIG. 3 is an electron microscopic observation photograph of the cross-sectional structure of the adhesive bonding layer in the magnet of Example 1 after expansion.

### DETAILED DESCRIPTION OF EMBODIMENTS

The following will describe in more detail the embodiments disclosed herein with reference to the accompanying drawings. Although certain embodiments are shown in the drawings, it should be understood that the embodiments disclosed herein can be implemented in various forms, and should not be interpreted as limited to the embodiments set forth herein. Rather, these embodiments are provided for a more thorough and complete understanding of the disclosure. It should be understood that the accompanying drawings and embodiments disclosed herein are for illustrative purposes only and are not intended to limit the scope of the disclosure.

The steps described in the implementation of this public method can be performed in different orders and/or in parallel. In addition, the method implementation may include additional steps and/or omit the steps shown. The scope of this disclosure is not limited in this regard.

In this disclosure, unless otherwise specified, phrases like “at least one of A, B, and C” and “at least one of A, B, or C” both mean only A, only B, only C, or any combination of A, B, and C.

The present disclosure provides a magnet with bond-coating, The magnet comprises a magnet matrix and a bond coating, The bond-coating is attached to at least part of the outer surface of the magnet matrix. The bond-coating is obtained after the attachment of an adhesive composition, which includes a base resin and a foaming agent. The foaming agent in the bond-coating is close to the magnet matrix, and the distribution height of the foaming agent is less 50% of the cross-sectional thickness of the bond-coating.

Optionally, the attachment methods include at least one of dip coating, blade coating, brush coating, roll coating, embossing, or spray coating.

Optionally, the bond-coating may be pre-cured after attachment with an adhesive composition. The pre-curing temperature is in a range from 40° C. to 90° C.

Optionally, the adhesive composition may be in the form of powder, liquid, or cloudy liquid.

Optionally, the foaming agent is at least one of expanded microspheres, azodicarbonamide, ammonium polyphosphate, azobisformamide, ammonium carbonate, and sodium bicarbonate.

Optionally, in one embodiment of the present disclosure, the foaming agent is concentrated in the middle and lower portion of the bond-coating, close to the surface of the magnet matrix. This arrangement ensures that the expansion cavities formed during the expansion process of the bond-coating are positioned as far as possible from contact with the magnetic conductor. As a result, a greater amount of the base resin in the bond-coating accumulates on the side away from the magnet matrix, thereby increasing the contact area between the base resin and the magnetic conductor. This enhances the bonding strength between the adhesive bonding layer and the magnetic conductor.

Optional, the thickness of the bond-coating ranges from 80 to 150 μm; the softening point of the bond-coating ranges from 60 to 80° C.; the expansion rate of the bond-coating ranges from 80% to 200%.

In one embodiment of the present disclosure, upon expansion of the bond-coating in a pressureless state, it is demonstrated that the expansion cavities formed during the expansion process of the bond-coating (characterized by the distribution height of the expansion cavities) are positioned closer to the side of the magnet matrix. Additionally, a greater amount of the base resin within the bond-coating accumulates on the side farther from the magnetic substrate. This arrangement enhances the bonding performance of the adhesive bonding layer.

Optionally, the content of the foaming agent is in a range from 0.5 parts to 20 parts by weight relative to 100 parts by weight of the base resin.

Optionally, the foaming agent is coated expandable microspheres, which include uncoated expandable microspheres and a coating layer on the outer surface of the uncoated expandable microspheres. The uncoated expandable microspheres comprise a polymer shell and an expandable matrix enclosed within the polymer shell. The coating layer comprises a coating resin and heavy inorganic filler embedded in the coating resin. The particle size of the uncoated expandable microspheres is in a range from 3 μm to 30 μm. The coating resin is a thermoplastic resin with a softening point ranging from 40° C. to 100° C., in some embodiments, acrylic resin, polyimide resin, and melamine-formaldehyde resin. The particle size of the heavy inorganic filler is in a range from 0.5 um to 30 um. The tapped density of the heavy inorganic filler ranges from 3.1 g/cm3 to 7.8 g/cm3. The heavy inorganic filler includes at least one of carbonates, phosphates, polyphosphates, metal oxides, and non-metallic compounds; in some embodiments, the carbonates include at least one of calcium carbonate, magnesium carbonate, and zinc carbonate; in some embodiments, the phosphates include at least one of calcium phosphate and sodium phosphate; in some embodiments, the polyphosphates include at least one of calcium polyphosphate and aluminum polyphosphate; in some embodiments, the metal oxides include at least one of aluminum oxide, rare earth oxides, and iron (III) oxide; in some embodiments, the non-metallic compounds include at least one of silicon dioxide, silicon nitride, and silicon carbide.

Optionally, relative to 1 part by weight of the uncoated expandable microspheres, the content of the coating resin is from 0.1 to 1.8 parts by weight, and the content of the heavy inorganic filler is from 1 to 15 parts by weight.

The density of the expandable microspheres is increased by incorporating heavy inorganic fillers, such that the microspheres concentrate in the middle and lower regions of the bond-coating, closer to the surface of the magnet matrix, under the influence of gravity. In contrast, existing uncoated expandable microspheres, which contain liquid alkanes within their polymeric shells, have a lower density and tend to be uniformly suspended throughout the bond-coating. By blending the uncoated expandable microspheres with heavy inorganic fillers to form the coated expandable microspheres, the density of the microspheres is controlled through the density range of the heavy inorganic fillers. This results in increased density and relative volume expansion of the microspheres, reducing their buoyancy and causing them to concentrate in the middle and lower parts of the adhesive composition. Prior to attaching the adhesive composition to the magnet matrix, the coated expandable microspheres are uniformly dispersed within the adhesive composition through agitation. After the adhesive composition is applied to the magnet matrix, during the settling process and pre-curing stage, the coated expandable microspheres sink and concentrate in the middle and lower regions of the bond-coating, closer to the surface of the magnet matrix, under the influence of gravity. This arrangement ensures that the expansion cavities formed during the expansion process of the bond-coating are positioned as far as possible from contact with the magnetic conductor, thereby increasing the contact area between the base resin of the bond-coating and the magnetic conductor. Consequently, the bonding strength between the adhesive bonding layer and the magnetic conductor is enhanced.

Optional, the expanded microspheres include uncoated expanded microspheres, heavy inorganic fillers, and encapsulating resin mixed together and then spray dried. Furthermore, the conditions for the spray drying include: temperature of 40° C. to 60° C., time of 0.1 min to 2 min.

In the present disclosure, the addition of a coating resin to the uncoated expandable microspheres and heavy inorganic fillers is intended to leverage the mediating and adhesive properties of the coating resin, enabling the heavy inorganic fillers to be sufficiently bonded to the surface of the polymer shell of the uncoated expandable microspheres. Additionally, the coated expandable microspheres are prepared using a spray drying method, which further prevents the separation of the heavy inorganic fillers from the uncoated expandable microspheres.

Optionally, the base resin includes thermosetting resin and thermoplastic resin. The weight ratio of the thermoplastic resin to the thermosetting resin is in a range from 1:1 to 1:10, in some embodiments, from 1:2 to 1:8.

The thermosetting resin is selected from epoxy resin, hydroxy-functional acrylic resin, and polyurethane resin, or a combination thereof. The epoxy resin is selected from bisphenol A epoxy resin, bisphenol F epoxy resin, and bisphenol S epoxy resin. In some embodiments, the epoxy resin is an acrylic-modified epoxy resin. In some embodiments, the epoxy resin is an acrylic-modified aqueous bisphenol S epoxy resin.

The thermosetting resin is at least one of epoxy resin, hydroxy acrylic resin, and polyurethane resin; the epoxy resin is one of bisphenol A type epoxy resin, bisphenol F type epoxy resin, and bisphenol S type epoxy resin. In some embodiments, the epoxy resin is acrylic-modified epoxy resin. In some embodiments, acrylic-modified water-based bisphenol S type epoxy resin.

The thermoplastic resin is at least one of acrylic resin, polysulfone resin, and melamine formaldehyde resin.

Optionally, the acrylic modified groups in the acrylic modified epoxy resin includes acrylic acid carboxyl monomers, acrylic acid hydroxyl monomers, and other monomers;

The acrylic acid carboxyl monomers include one of acrylic acid group, methacryl diacid group, and methyl acrylic acid group.

The acrylate hydroxyl monomers include one of the methacrylic acrylate glycerol ester group and the methyl methacrylate group.

The other monomers include a hydroxymethyl acrylamide group and a styrene group.

Optionally, the adhesive composition further includes reinforcing resin particles. The reinforcing resin particles comprise lightweight inorganic fillers, high-adhesion resins and dispersing resins adhered to the surface of the lightweight inorganic fillers, and a filling gas encapsulated within the high-adhesion resins and dispersing resins.

Optionally, the reinforcing resin particles are prepared by mixing lightweight inorganic fillers, high-adhesion resins, dispersing resins, and a solvent to form a mixture, followed by spray drying the mixture.

Optionally, the lightweight inorganic fillers include at least one of fumed silica and fumed alumina. The high-adhesion resins include at least one of β-hydroxyethyl acrylate resin, hydantoin epoxy resin, and tris(aminomethyl)phosphine epoxy resin. The dispersing resins are thermoplastic resins with a softening point ranging from 40° C. to 100° C., in some embodiments, including at least one of acrylic resin, methacrylic resin, polysulfone resin, melamine-formaldehyde resin, and polyolefin resin. The filling gas includes at least one of air, nitrogen, carbon dioxide, hydrogen, and helium.

Optionally, the reinforcing resin particles have a particle size ranging from 0.5 to 30 micrometers (μm). Relative to 1 part by weight of the lightweight inorganic filler, the content of the high-adhesion resin is from 1 to 8 parts by weight, and the content of the dispersing resin is from 1 to 10 parts by weight.

Optionally, the lightweight inorganic filler has a specific surface area ranging from 150 to 400 square meters per gram (m²/g) and a tapped density ranging from 0.02 to 0.20 grams per cubic centimeter (g/cm³). The β-hydroxyethyl acrylate resin has a molecular weight ranging from 5,000 to 50,000 Daltons, in some embodiments, from 10,000 to 21,000 Daltons.

In the present disclosure, the addition of lightweight inorganic fillers such as fumed silica and/or fumed alumina leverages their high affinity and surface tension to effectively adsorb the high-adhesion resin, thereby securing it within the reinforcing resin particles. Additionally, due to their low density, these fillers significantly reduce the overall density of the reinforcing resin particles. The incorporation of filling gases further enhances the buoyancy of the reinforcing resin particles during heating, overcoming gravitational forces. The synergistic action of the lightweight inorganic fillers and filling gases enables the reinforcing resin particles to concentrate longitudinally and distribute uniformly across the surface of the bonding coating. Upon heating, these particles can further overcome gravitational forces and the resistance from the base resin to rise upward.

In this disclosure, the addition of high-adhesive resin can effectively increase the bonding ability of the strengthening resin particles to prevent collapse of the expansion space.

Optionally, in one embodiment of the present disclosure, relative to 100 parts by weight of the base resin, the content of the reinforcing resin particles is in a range from 1 to 15 parts by weight.

Optionally, in one embodiment of the present disclosure, the weight ratio of the thermoplastic resin to the thermosetting resin is from 1:1 to 1:10, in some embodiments, from 1:2 to 1:8.

Optionally, in one embodiment of the present disclosure, the adhesive composition further comprises at least one additive selected from the group consisting of leveling agents, anti-settling agents, dispersants, defoamers, curing agents, film-forming aids, and medium-weight inorganic fillers. The leveling agent includes at least one of silicone oil leveling agents and polysiloxane leveling agents. Relative to 100 parts by weight of the base resin, the content of the additive is from 1 to 9 parts by weight. The anti-settling agent includes at least one of silica anti-settling agents and organically modified bentonite anti-settling agents. The defoamer includes at least one of polysiloxane defoamers and fatty acid ester defoamers. The dispersant includes at least one of magnesium stearate dispersants and sodium oleate dispersants. The film-forming aid includes at least one of butyl cellosolve film-forming aids and butyl carbitol film-forming aids. The curing agent includes at least one of phenolic resin curing agents and aliphatic polyamine curing agents. The aliphatic polyamine curing agent includes at least one of ethylenediamine, diethylenetriamine, and triethylenetetramine. The medium-weight inorganic filler has a particle size ranging from 0.5 to 30 micrometers (μm) and a tapped density ranging from 2.1 to 3.0 grams per cubic centimeter (g/cm³), and includes at least one of calcium oxide, zinc oxide, calcium carbonate, and inorganic fibers. The inorganic fibers include at least one of carbon fibers, metal fibers, and glass fibers.

The present disclosure also provides a magnetic assembly, which includes the aforementioned magnet and magnetic conductor. Positioned between the magnet and the conductor is an adhesive bonding layer obtained after thermal curing of the bond-coating at a temperature ranging from 150° C. to 200° C. The bonding coating exhibits a shear strength ranging from 1 MPa to 15 MPa under ambient conditions, and a shear strength from 1 MPa to 10 MPa under high-temperature conditions ranging from 120° C. to 180° C.

Optionally, the adhesive bonding layer obtained after thermal curing contains expansion bubbles. These expansion bubbles are adjacent to the magnet matrix, and the distribution height of the expansion bubbles is less than 80% of the thickness of the cross-section of the adhesive bonding layer obtained after thermal curing. Upon expansion of the bond-coating in a pressureless state, it is demonstrated that the expansion cavities formed during the expansion process of the bond-coating (characterized by the distribution height of the expansion cavities) are positioned closer to the side of the magnet matrix. Additionally, a greater amount of the base resin within the bond-coating accumulates on the side farther from the magnetic substrate. This arrangement enhances the bonding performance of the adhesive bonding layer.

The present disclosure further provides an electrical device, the electrical device comprising the magnetic assembly as described above.

The following further illustrates the present disclosure through implementation examples. Unless otherwise specified, the raw materials used in the examples can be obtained through commercial channels.

In the following Examples and Comparisons disclosed herein, the testing method of the samples is as follows:

The expansion rate test conditions are as follows: A magnet with bond-coating, under pressureless conditions (not assembled with the magnetic conductor), is heated at 180° C. for 30 minutes. The change in thickness of the bond-coating is recorded. The expansion rate (%) is calculated as (thickness after expansion-thickness before expansion)/thickness before expansion.

The neutral salt spray test conditions are as follows: At 35° C., a NaCl aqueous solution with a concentration of (5±0.5) %, and a pH value between 6.5 and 7.2, is atomized to form salt fog that settles on the test magnet products. The time until rusting occurs on the surface of the magnet is recorded.

The shear strength test conditions are in accordance with GB/T 7124-2008 (Determination of the Shear Strength of Adhesives by the Stair-Step Method (Rigid Material to Rigid Material)).

The oil resistance test conditions are as follows: Neodymium-iron-boron magnets are fully immersed in transmission oil at 150° C., and observations are made for rust, blistering, peeling, and other conditions on the magnet surface. The time until changes in the magnet's surface coating occur is recorded. Additionally, the performance of the magnet's coating is retested, and the time until no impact on the coating performance is observed is recorded as the oil resistance time.

### Embodiment 1

Preparation of Coated Expandable Microspheres: Under the condition that the solvent is ethanol, 1 part by weight of uncoated expanded microspheres (with a particle size ranging from 5 μm to 15 μm) is mixed with 3 parts by weight of heavy inorganic filler (calcium polyphosphate, with a particle size ranging from 20 μm to 30 μm and a tapped density of 3.14 g/cm³) and 0.5 part by weight of coating resin (acrylic resin) to obtain a mixture. Then, the mixture is spray-cooled and dried. The conditions of spray drying include: a temperature of 60° C. and a time of 1 minute, and the coated expanded microspheres are obtained.

Preparation of the Adhesive Composition: Under the condition that the solvent is water, 80 parts by weight of an acrylic-modified waterborne bisphenol S epoxy resin (with a molecular weight of 20,000 daltons, and the modifying groups are itaconic acid, acrylic acid, hydroxymethyl acrylamide and glycidyl methacrylate, and the initiator is benzoyl peroxide) is mixed with 20 parts by weight of a waterborne acrylic resin, 8 parts by weight of the coated expanded microspheres, 1 part by weight of a phenolic resin curing agent, 0.2 part by weight of a silicone oxane leveling agent, and 0.2 part by weight of an ethylene glycol butyl ether film-forming aid at a stirring rate of 500 rpm to obtain the adhesive composition.

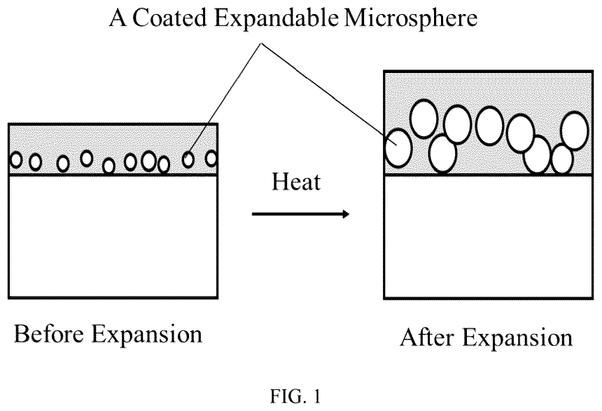

Using the brush coating method, as shown in FIG. 1, the adhesive composition is coated on a magnetic substrate (neodymium-iron-boron magnet), and is pre-cured at 50° C. for 20 minutes to obtain a bond-coating with a thickness of 100 μm.

A silicon steel magnetic conductor is assembled on the bond-coating, and then heat-cured at 200° C. to obtain a magnet component, designated as Sample 1.

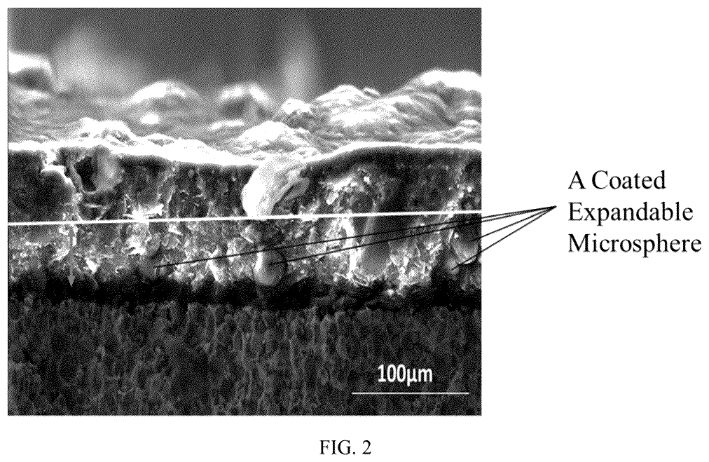

The cross-sectional structure of the bond-coating in the magnet of this example is observed by an electron microscope, as shown in FIG. 2. According to FIG. 2, in the bond-coating, the foaming agent is close to the magnet matrix, and the distribution height of the expanding agent is less than 50% of the cross-sectional thickness of the bond-coating.

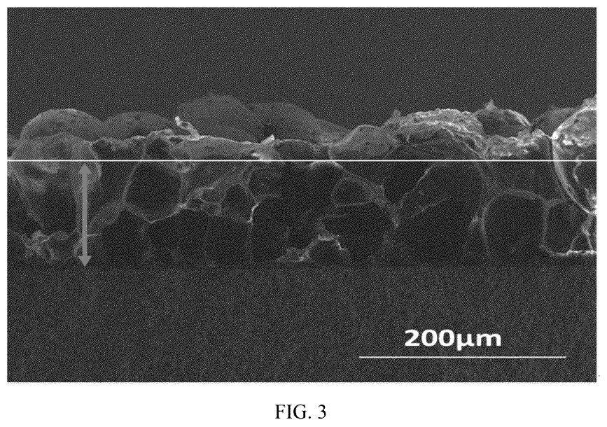

The cross-sectional structure of the bond-coating in the magnet of this example is observed by an electron microscope after it freely expands at 200° C. in a pressure-free state (without assembling the magnetic conductor), as shown in FIG. 3. According to FIG. 3, the adhesive bonding layer obtained after heat curing has expansion bubbles, the expansion bubbles are close to the magnet matrix, and the distribution height of the expansion bubbles is less than 80% of the cross-sectional thickness of the adhesive bonding layer obtained after heat curing.

### Embodiment 2

Preparation of Coated Expandable Microspheres: Under the condition that the solvent is ethanol, 1 part by weight of uncoated expanded microspheres (with a particle size ranging from 5 μm to 15 μm) is mixed with 3 parts by weight of heavy inorganic filler (aluminum polyphosphate (with a particle size ranging from 0.2 μm to 5 μm and a tapped density of 3.2 g/cm³)) and 1 part by weight of coating resin (acrylic resin) to obtain a mixture. Then, the mixture is spray-cooled and dried. The conditions of spray drying include: a temperature of 60° C. and a time of 1 minute, and the coated expandable microspheres are obtained.

Preparation of the Adhesive Composition: Under the condition that the solvent is water, 80 parts by weight of an acrylic-modified waterborne bisphenol F epoxy resin (with a molecular weight of 20,000 daltons, and the modifying groups are itaconic acid, acrylic acid, hydroxymethyl acrylamide and glycidyl methacrylate, and the initiator is benzoyl peroxide) is mixed with 20 parts by weight of a waterborne acrylic resin, 12 parts by weight of the coated expanded microspheres, 1 part by weight of a phenolic resin curing agent, 0.2 part by weight of a silicone oxane leveling agent, and 0.2 part by weight of an ethylene glycol butyl ether film-forming aid at a stirring rate of 500 rpm to obtain the adhesive composition.

Using the embossing method, the adhesive composition is coated on a magnet matrix (neodymium-iron-boron magnet), and is pre-cured at 50° C. for 20 minutes to obtain a bond-coating with a thickness of 60 μm.

A silicon steel magnetic conductor is assembled on the bond-coating, and then heat-cured at 200° C. to obtain a magnet component, designated as Sample 2.

### Embodiment 3

Preparation of Reinforcing Resin Particles: Under the condition that the solvent is ethanol, 1 part by weight of light inorganic filler (fumed silica, with a specific surface area of 150 m²/g and a tapped density of 0.05 g/cm³) is mixed with 3 parts by weight of highly adhesive resin (β-hydroxyethyl acrylate resin, with a molecular weight of 21,000 daltons) and 7 parts by weight of dispersible resin (acrylic resin, with a softening point of 45° C.). During the mixing process, filling gas (air) is introduced at a gas flow rate of 1 ml/min, and the mixing is carried out at a stirring rate of 500 rpm to obtain a mixture. The mixture is then spray-dried. The conditions of spray drying include: a temperature of 40° C. and a time of 0.1 minute, and the reinforcing resin particles are obtained.

Preparation of the Adhesive Composition: Under the condition that the solvent is water, 75 parts by weight of an acrylic-modified waterborne epoxy resin (with a molecular weight of 20,000 daltons, and the modifying groups are itaconic acid, acrylic acid, hydroxymethyl acrylamide and glycidyl methacrylate, and the initiator is benzoyl peroxide) is mixed with 15 parts by weight of a waterborne acrylic resin, 5 parts by weight of the reinforced resin particles, 1 part by weight of uncoated expandable microspheres (with a particle size ranging from 5 μm to 15 μm), 1 part by weight of a phenolic resin curing agent, 0.2 part by weight of a silicone oxane leveling agent, and 0.2 part by weight of an ethylene glycol butyl ether film-forming aid at a stirring rate of 500 rpm to obtain the adhesive composition.

Using the brush coating method, the adhesive composition is coated on a magnet matrix (neodymium-iron-boron magnet), and is pre-cured at 50° C. for 20 minutes to obtain a magnet with a bond-coating having a thickness of 100 μm.

A silicon steel magnetic conductor is assembled on the bond-coating, and then heat-cured at 200° C. to obtain a magnet component, designated as Sample 3.

### Embodiment 4

Preparation of Reinforced Resin Particles: Under the condition where the solvent is ethanol, 1 part by weight of light inorganic filler (fumed silica, with a specific surface area of 150 m²/g and a tapped density of 0.05 g/cm³) is mixed with 4 parts by weight of highly adhesive resin (β-hydroxyethyl acrylate resin, having a molecular weight of 21,000 daltons) and 7 parts by weight of dispersible resin (acrylic resin, with a softening point of 45° C.). During the mixing process, filling gas (air) is introduced with a gas flow rate of 8 ml/min, and the mixture is stirred at a rate of 100 rpm to obtain a mixture. Then, the mixture is spray-dried. The spray-drying conditions include a temperature of 60° C. and a time of 2 minutes, and the reinforced resin particles are obtained.

Preparation of the Adhesive Composition: Under the condition where the solvent is water, 70 parts by weight of acrylic-modified waterborne epoxy resin (with a molecular weight of 20,000 daltons, and the modifying groups being itaconic acid, acrylic acid, hydroxymethyl acrylamide and glycidyl methacrylate, and the initiator being benzoyl peroxide) is mixed with 20 parts by weight of waterborne acrylic resin, 8 parts by weight of the reinforced resin particles, 3 parts by weight of uncoated expanded microspheres (with a particle size ranging from 5 to 20 μm), 1 part by weight of phenolic resin curing agent, 0.5 part by weight of silicone oxane leveling agent, and 1 part by weight of ethylene glycol butyl ether film-forming aid. The mixture is stirred at a rate of 100 rpm to obtain the adhesive composition.

Using the dipping method, the adhesive composition is coated on a magnet matrix (neodymium-iron-boron magnet). It is allowed to stand for pre-curing at 50° C. for 20 minutes, and a magnet with a bonding-coating having a thickness of 100 μm is obtained.

A silicon steel magnetic conductor is assembled on the bonding-coating, and then heat-cured at 200° C. to obtain a magnet component, designated as Sample 4.

### Embodiment 5

Preparation of Reinforced Resin Particles: Under the condition that the solvent is ethanol, 1 part by weight of light inorganic filler (fumed silica, with a specific surface area of 150 m₂/g and a tapped density of 0.05 g/cm³) is mixed with 3 parts by weight of highly adhesive resin (β-hydroxyethyl acrylate resin, with a molecular weight of 21,000 daltons) and 7 parts by weight of dispersible resin (acrylic resin, with a softening point of 45° C.). During the mixing process, filling gas (air) is introduced at a gas flow rate of 1 ml/min, and the mixing is carried out at a stirring rate of 500 rpm to obtain a mixture. The mixture is then spray-dried. The conditions of spray drying include: a temperature of 40° C. and a time of 0.1 minute, and the reinforced resin particles are obtained.

Preparation of Coated Expandable Microspheres: Under the condition that the solvent is ethanol, 1 part by weight of uncoated expanded microspheres, 5 parts by weight of aluminum polyphosphate (with a particle size ranging from 0.2 μm to 5 μm and a tapped density of 3.5 g/cm³), and 0.5 part by weight of acrylic resin (with a softening point of 40° C.) are mixed. The mixing is carried out at a stirring rate of 500 rpm to obtain a mixture. The mixture is then spray-dried. The conditions of spray drying include: a temperature of 60° C. and a time of 1 minute, and the coated expandable microspheres are obtained.

Preparation of the Adhesive Composition: Under the condition that the solvent is water, 70 parts by weight of an acrylic-modified waterborne epoxy resin (with a molecular weight of 20,000 daltons, and the modifying groups are itaconic acid, acrylic acid, hydroxymethyl acrylamide and glycidyl methacrylate, and the initiator is benzoyl peroxide) is mixed with 20 parts by weight of a waterborne acrylic resin, 5 parts by weight of the reinforced resin particles, 10 parts by weight of the coated expandable microspheres, 1 part by weight of a phenolic resin curing agent, 0.2 part by weight of a silicone oxane leveling agent, and 0.2 part by weight of an ethylene glycol butyl ether film-forming aid at a stirring rate of 500 rpm to obtain the adhesive composition.

Using the brush coating method, the adhesive composition is coated on a magnet matrix (neodymium-iron-boron magnet), and is pre-cured at 50° C. for 20 minutes to obtain a magnet with a bond-coating having a thickness of 120 μm.

A silicon steel magnetic conductor is assembled on the bond-coating, and then heat-cured at 200° C. to obtain a magnetic assembly, designated as Sample 5.

### Comparative Embodiment 1

Under the condition that the solvent is water, 80 parts by weight of an acrylic-modified waterborne epoxy resin (with a molecular weight of 20,000 daltons, the modifying groups being itaconic acid, acrylic acid, hydroxymethyl acrylamide, and glycidyl methacrylate, and the initiator being benzoyl peroxide) is mixed with 20 parts by weight of a waterborne acrylic resin, 1.7 parts by weight of uncoated expanded microspheres, 1 part by weight of a phenolic resin curing agent, 0.2 part by weight of a silicone oxane leveling agent, and 0.2 part by weight of an ethylene glycol butyl ether film-forming aid. The mixture is stirred at a rate of 500 rpm to obtain an adhesive composition.

Using the brush coating method, the adhesive composition is applied to a magnet matrix (a neodymium-iron-boron magnet) and pre-cured by allowing it to stand at 50° C. for 20 minutes to obtain a bond-coating with a thickness of 100 μm.

A silicon steel magnetic conductor is assembled on the bond-coating and then heat-cured at 200° C. to obtain a magnetic assembly, designated as Comparative Sample 1.

### Comparative Embodiment 2

The method is the same as in Example 1, except that no coating resin is added to the expandable microspheres.

Using the brush-coating method, the adhesive composition is applied to a magnet matrix (a neodymium-iron-boron magnet). It is left to stand at 50° C. for 20 minutes for pre-curing, and a bond-coating with a thickness of 100 μm is obtained.

A silicon steel magnetic conductor is assembled on the bond-coating and then heat-cured at 200° C. to obtain a magnetic assembly, designated as Comparative Sample 2.

### Comparative Embodiment 3

The method is the same as that in Example 3, except that fumed silica is not added to the reinforced resin particles.

Using the brush coating method, the adhesive composition is applied to a magnet matrix (a neodymium-iron-boron magnet). The substrate is left to stand at 50° C. for 20 minutes for pre-curing, and a magnet with a bond-coating having a thickness of 100 μm is obtained.

A silicon steel magnetic conductor is assembled on the bond-coating and then heat-cured at 200° C. to obtain a magnetic assembly, designated as Comparative Sample 3.

### Comparative Embodiment 4

The method is the same as that in Example 3, except that the β-hydroxyethyl acrylate resin in the reinforced resin particles is replaced with acrylic resin.

Using the brush-coating method, the adhesive composition is applied onto the neodymium-iron-boron magnetic substrate. The substrate is allowed to stand at 50° C. for 20 minutes for pre-curing, and a magnet with a bond-coating having a thickness of 100 μm is obtained.

A silicon steel magnetic conductor is assembled on the bond-coating and then heat-cured at 200° C. to obtain a magnetic assembly, designated as Comparative Sample 4.

The sample treatment conditions and test results of Samples 1-5 and Comparative Samples 1-4 are shown in Table 1.

TABLE 1

| | | Shear | Shear | | | |
|---|---|---|---|---|---|---|
| | | strength of | strength | | | |
| | | the adhesive | of the | Neutral salt | | |
| | | bonding | adhesive | spray | | |
| | | layer in the | bonding | resistance | Oil resistance | Expansion rate |
| | | sample at | layer in | duration of | duration of | of the bond- |
| | Expansion | room | the | the adhesive | the adhesive | coating in the |
| | rate of | temperature | sample at | bonding | bonding | sample after |
| | the bond- | (MPa)/ | 160° C./ | layer after | layer in the | 2-month |
| | coating/% | Mpa | Mpa | curing/h | sample/h | storage/% |
| Embodiment 1 | 110 | 6.82 | 1.58 | 300 | 2500 | 110 |
| Embodiment 2 | 125 | 6.91 | 1.65 | 300 | 2500 | 125 |
| Embodiment 3 | 90 | 7.16 | 2.14 | 310 | 2500 | 80 |
| Embodiment 4 | 160 | 7.18 | 2.25 | 310 | 2500 | 145 |
| Embodiment 5 | 130 | 7.26 | 2.34 | 310 | 2500 | 130 |
| Comparative | 80 | 6.45 | 1.51 | 290 | 2480 | 50 |
| Embodiment 1 | | | | | | |
| Comparative | 110 | 6.15 | 1.45 | 290 | 2500 | 60 |
| Embodiment 2 | | | | | | |
| Comparative | 90 | 6.85 | 1.84 | 300 | 2500 | 40 |
| Embodiment 3 | | | | | | |
| Comparative | 90 | 6.15 | 1.36 | 300 | 2500 | 35 |
| Embodiment 4 | | | | | | |

Based on the data in Table 1, by comparing the embodiments and comparative embodiments, it can be seen that when the adhesive composition contains the expandable microspheres, coating resin, and reinforced resin particles of the present disclosure, the expansion rate of the bond-coating can basically maintain its original expansion ability after two-month storage. The shear strength of the adhesive bonding layer at both room temperature and 160° C. is better, especially the shear strength performance at 160° C. is particularly remarkable.

Some embodiments of the present disclosure have been described in detail above with reference to the accompanying drawings. However, the present disclosure is not limited to the specific details in the above-mentioned embodiments. Within the scope of the technical concept of the present disclosure, various simple modifications can be made to the technical solutions of the present disclosure, and these simple modifications all fall within the protection scope of the present disclosure.

In addition, it should be noted that the various specific technical features described in the above-mentioned specific embodiments can be combined in any suitable way as long as there is no contradiction. To avoid unnecessary repetition, the present disclosure does not separately describe all possible combination ways.

Furthermore, any combination can be made among the various different embodiments of the present disclosure, as long as it does not violate the idea of the present disclosure, and it should also be regarded as the content disclosed in the present disclosure.

1. A magnet comprising:
a magnet matrix; and
a bond-coating attached to at least part of an outer surface of the magnet matrix and including an adhesive composition;
wherein:
the adhesive composition includes:
a base resin including thermosetting resin and thermoplastic resin; and
a foaming agent; and
in the bond-coating, the foaming agent is close to the magnet matrix, and a distribution height of the foaming agent is less than 50% of a thickness of the bond-coating in a cross-section.

2. The magnet according to claim 1, wherein:
the thickness of the bond-coating is in a range of 80 μm to 150 μm;
a softening point of the bond-coating is in a range of 60° C. to 80° C.; and
an expansion rate of the bond-coating is in a range of 80% to 200%.

3. The magnet according to claim 1, wherein a ratio of a weight of the foaming agent to a weight of the base resin is in a range of 0.005 to 0.2.

4. The magnet according to claim 1, wherein:
the foaming agent includes a coated expandable microsphere, and the coated expandable microsphere includes an uncoated expandable microsphere and a coating layer coated on an outer surface of the uncoated expandable microsphere;
the uncoated expandable microsphere includes a polymer shell and an expandable matrix encapsulated in the polymer shell, and the coating layer includes a coating resin and a heavy inorganic filler embedded in the coating resin;
a particle size of the uncoated expandable microsphere is in a range from 3 μm to 30 μm;
the coating resin includes a thermoplastic resin with a softening point ranging from 40° C. to 100° C.;
a particle size of the heavy inorganic filler is in a range from 0.5 μm to 30 μm, and a tapped density of the heavy inorganic filler is in a range from 3.1 g/cm³ to 7.8 g/cm³; and
the heavy inorganic filler includes at least one of carbonates, phosphates, polyphosphates, metal oxides, and non-metal compounds, the carbonates including at least one of calcium carbonate, magnesium carbonate, and zinc carbonate, the phosphates including at least one of calcium phosphate and sodium phosphate, the polyphosphates including at least one of calcium polyphosphate and aluminum polyphosphate, the metal oxides including at least one of aluminum oxide, rare-earth oxides, and ferroferric oxide, and the non-metal compounds including at least one of silicon dioxide, silicon nitride, and silicon carbide.

5. The magnet according to claim 4, wherein a ratio of a weight of the coating resin to a weight of the uncoated expandable microsphere is from 0.1 to 1.8, and a ratio of a weight of the heavy inorganic filler to the weight of the uncoated expandable microsphere is from 1 to 15.

6. The magnet according to claim 1, wherein:
a weight ratio of the thermoplastic resin to the thermosetting resin is in a range of 1:1 to 1:10;
the thermosetting resin is selected from epoxy resin, hydroxy-functional acrylic resin, and polyurethane resin, or a combination thereof, and the epoxy resin is selected from bisphenol A epoxy resin, bisphenol F epoxy resin, and bisphenol S epoxy resin;
the thermoplastic resin includes at least one of acrylic resin, polysulfone resin, and melamine formaldehyde resin.

7. The magnet according to claim 6, wherein:
the epoxy resin includes an acrylic modified epoxy resin;
acrylic modified groups in the acrylic modified epoxy resin include acrylic acid carboxyl monomers, acrylic acid hydroxyl monomers, and other monomers;
the acrylic acid carboxyl monomers include one of acrylic acid group, methacryl diacid group, and methyl acrylic acid group;
the acrylate hydroxyl monomers include one of methacrylic acrylate glycerol ester group and methyl methacrylate group; and
the other monomers include a hydroxymethyl acrylamide group and a styrene group.

8. The magnet according to claim 1, wherein the adhesive composition further includes reinforcing resin particles including lightweight inorganic fillers, high-adhesion resins and dispersing resins adhered to surfaces of the lightweight inorganic fillers, and a filling gas

9. The magnet according to claim 8, wherein:
the lightweight inorganic fillers include at least one of fumed silica and fumed alumina;
the highly adhesive resins include at least one of β-hydroxyethyl acrylate resin, hydantoin epoxy resin, and phosphazene epoxy resin;
the dispersing resins include thermoplastic resins with a softening point ranging from 40° C. to 100° C.; and
the filling gas includes at least one of air, nitrogen, carbon dioxide, hydrogen, and helium.

10. The magnet according to claim 8, wherein:
a particle size of the reinforcing resin particles is in a range from 0.5 μm to 30 μm; and
a ratio of a weight of the lightweight inorganic filler to a weight of the high-adhesion resin is from 1 to 8, and a ratio of a weight of the dispersing resin to the weight of the high-adhesion resin is from 1 to 10.

11. The magnet according to claim 8, wherein:
the lightweight inorganic filler has a specific surface area ranging from 150 to 400 square meters per gram (m²/g) and a tapped density ranging from 0.02 to 0.20 grams per cubic centimeter (g/cm³); and
the β-hydroxyethyl acrylate resin has a molecular weight ranging from 5,000 to 50,000 Daltons.

12. The magnet according to claim 8, wherein a ratio of a weight of the reinforcing resin particles to a weight of the base resin is in a range from 0.01 to 0.15.

13. The magnet according to claim 1, wherein the bond-coating is obtained by pre-curing the adhesive composition at a pre-curing temperature in a range from 40° C. to 90° C.

14. A magnetic assembly comprising:
a magnet;
a magnetic conductor; and
an adhesive bonding layer between the magnet and the magnetic conductor, and containing expansion bubbles adjacent to a magnet matrix of the magnet, a distribution height of the expansion bubbles being less than 80% of a thickness of the adhesive bonding layer in a cross-section.

15. An electrical device comprising the magnetic assembly according to claim 14.
